(19) United States
(12) Patent Application Publication
(10) Pub. No.: US 2008/0189721 A1
(43) Pub. Date: Aug. 7, 2008

(54) EMERGENCY NOTIFICATION SYSTEM

(76) Inventor: Warren J. Buchanan, Tuskegee, AL (US)

Correspondence Address: CANTOR COLBURN, LLP, 20 Church Street, 22nd Floor, Hartford, CT, 06103, US

(21) Appl. No.: 12/027,188

(22) Filed: Feb. 6, 2008

Related U.S. Application Data
(60) Provisional application No. 60/899,754, filed on Feb. 6, 2007.

(51) Int. Cl. G06F 13/00; G06F 3/00

(52) U.S. Cl. 719/318; 710/48

(57) ABSTRACT

Methods, systems, servers, and communications devices for emergency notification are provided. An administrator login is received and input of an emergency notification is received. A selection corresponding to multiple client devices is received. The emergency notification is transmitted to the multiple client devices. The emergency notification causes an interruption at the multiple client devices, and the emergency notification is presented at the multiple client devices.

This application claims the benefit of Provisional Application 60/899,754, the contents of which are herein incorporated by reference.

### BACKGROUND

1. Field of the Invention

Exemplary embodiments relate to an emergency notification system, and more particularly, to providing emergency notifications to communication devices.

2. Description of Background

In today's world, many unexpected events may occur. Communication failures can plague organizations in their ability to respond to and minimize the human, operational, and financial impact of an emergency. In the event of a disaster, such as an attack or a natural disaster, it is important to alert those who are affected or who will be affected by the disaster. In the past, television stations and radio stations would broadcast Emergency Broadcast System announcements and tests in the event of an emergency.

As technology has advanced, and in light of recent attacks and natural disasters, a centralized system is needed for alerting individuals of emergency situations. Also, systems and techniques are needed to provide accurate and specialized information to those affected or who will be affected by the emergency situation.

### SUMMARY

Exemplary embodiments include a method for emergency notification. An administrator login is received and input of an emergency notification is received. A selection corresponding to a plurality of client devices is received. The emergency notification is transmitted to the plurality of client devices. The emergency notification causes an interruption at the plurality of client devices, and the emergency notification is presented at the plurality of client devices.

Additional exemplary embodiments include a server configured to provide emergency notification services. Memory stores a server module for providing emergency notification. A processor is functionally coupled to the memory and is responsive to computer-executable instructions contained in the server module. The server module may receive an administrator login, receive input of an emergency notification, receive a selection corresponding to a plurality of client devices, and transmit the emergency notification to the plurality of client devices. The emergency notification causes an interruption at the plurality of client devices. The emergency notification is presented at the plurality of client devices.

Further exemplary embodiments include a communications device configured to receive emergency notifications. Memory stores a client module for providing emergency notification. A processor is functionally coupled to the memory and the processor is responsive to computer-executable instructions contained in the client module. The client module receives an emergency notification at the communications device and causes an interruption at the communications device in response to receiving the emergency notification. The interruption renders programs running on the communications device inoperable during the interruption. The client module presents the emergency notification at the communication device.

Additional exemplary embodiments include a computer program product, tangibly embodied on a computer readable medium, for providing emergency notification. The computer program product includes instructions for causing a computer to execute the above method.

System and computer program products corresponding to the above-summarized methods are also described and claimed herein.

Additional features are realized through the techniques of the present invention. Other exemplary embodiments are described in detail herein and are considered a part of the claimed invention. For a better understanding of the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features are apparent from the following detailed description taken in conjunction with the accompanying drawings in which:

FIG. 1 illustrates a block diagram of a system in accordance with exemplary embodiments;

FIG. 2 illustrates an example of a server interacting with a client device in accordance with exemplary embodiment;

FIG. 3 illustrates an example of an administration panel in accordance with exemplary embodiments;

FIG. 4 illustrates an example of a method for providing emergency notifications in accordance with exemplary embodiments;

FIG. 5 illustrates a non-limiting example of implementing an emergency notification system on a college campus in accordance with exemplary embodiments; and

FIG. 6 illustrates an example of a computer having capabilities that may be included in exemplary embodiments.

The detailed description explains exemplary embodiments by way of example with reference to the drawings.

### DETAILED DESCRIPTION OF EXEMPLARY EMBODIMENTS

Exemplary embodiments provide an emergency notification system for alerting individuals or groups. The emergency notification system may consist of both a client component that can be a single executable file and a server component to manage the operations of the emergency notification system. The emergency notification system has the ability to operate on multiple or cross platforms. The emergency notification system may be a stand-alone platform for delivering instantaneous, all-encompassing emergency notifications.

Exemplary embodiments may run numerous functions including instant text notifications streaming audio, streaming video, and alert flags (such as the Department of Homeland Security alert flag) alone or when bundled with any one of the premium third party marketed mass telephony, pager, email, or text based notification systems.

In accordance with exemplary embodiments, the server module will notify the client module of an alert that is transmitted to the client by posting a notification window on the client module's computer screen. The client module may be a hidden system process with low system resource overhead so as not to diminish the capacity of the client module operating system.

The client module may notify the server module once the message has been received by the authorized user. In exemplary embodiments, there may be multiple levels of security sets that can be designed, e.g., from simple screen notification, notification with an acknowledgment to the server, notification with any number of report options to the server module, to freezing the client module's computer system with password protected entry required to receive the notification and to unlock the client module's computer system.

The emergency notification system includes the ability to interact with a third party telephony based contact system and to receive and accumulate data from such telephony devices and system. Further, the emergency notification system may be used as a remotely triggered module to create a secure desktop lock.

In accordance with exemplary embodiments, the system may be used as a monitoring device with the user setting the variables such as key strokes or website content to trigger the locking of the desktop and prohibit the user any further use of the system without the proper release credentials.

Furthermore, the emergency system notification may provide a means of mass notification within defined standards to the client users. The emergency notification system provides a method for accumulating and reporting responses from the client module users, such as acknowledgment of the message or a response to a query posed in the notification to the client module user. The emergency notification system also has the ability to interact with third party notification systems to reach users of the system who are not directly connected to server module through such devices as telephony, pager, email, or text based notification systems.

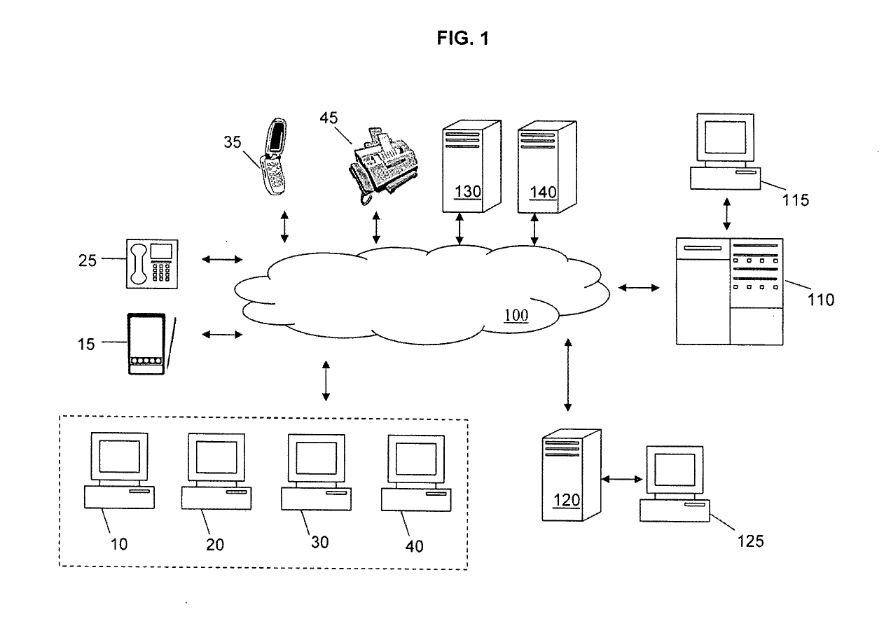

Turning now to the drawings in greater detail, FIG. 1 illustrates a block diagram of a system 100 in accordance with exemplary embodiments. The system 100 provides a non-limiting example of elements that may, but not necessarily, be included in an emergency notification system. The system 100 provides an infrastructure through which administrators can provide and users can access media (including video, audio, data, multimedia messaging, text messaging, etc.) through a plurality of communications devices, such as client devices 10, 20, 30, 40 or any other type communications device. It is understood that in exemplary embodiments and implementations, the communications devices can be a variety of communications devices, such as general purpose or laptop computers, wireless devices such as cellular telephones, portable computing device, digital music players (e.g., MP3 players), mobile devices. Internet protocol enabled televisions, navigation systems, etc. In addition, a wireline public switched telephone network (PSTN) telephone, session initiation protocol (SIP) telephone, dual-mode mobile telephone, personal digital assistant (PDA), or other type of communications device may be included in the system 100 of FIG. 1.

As a non-limiting example, the system 100 may include a server 110 that can be a master server (or host server) comprising all the functionality for implementing the emergency notification system. The server 110 may communicate via a network 100 with a plurality of communication devices, such as the client devices 10, 20, 30, 40, a personal digital assistant (PDA) 15, a telephone 25, a mobile communications device 35, a facsimile machine 45, etc. Also, the server 110 may interact with a plurality of servers, such as servers 120, 130, 140, via the network 100. The server 110 may serve as a backup to one or more of the servers 120, 130, 140. Also, one or more of the servers 110, 120, 130, 140 may serve as a back-end server and/or an authentication server for implementing emergency notification services. For example, as an authentication server, the server may implement authentication software for restricting or controlling access to emergency network services. The server may include a customer identity system (CIS) database, which stores user credentials (e.g., user names and passwords) and preferences.

In accordance with exemplary embodiments, access to the network 100 is not meant to be limiting in any way. The network 100 may include circuit-switched and/or packet-switched technologies and devices, such as routers, switches, hubs, gateways, etc., for facilitating communications over the network 100. The network 100 may include wireline and/or wireless components utilizing, e.g., IEEE 802.11 standards for providing over-the-air transmissions of communications. The network 100 can include IP-based networks and can facilitate communications over the Internet.

Also, the network 100 may include wireline and/or wireless components utilizing standards for, e.g. multimedia messaging services (MMS). The network 100 may include a multimedia messaging center (MMC), which implements the network side of multimedia messaging service (MMS) and makes it possible for an operator to offer multimedia messaging to mobile communication device users. The MMC is a highly flexible system, which can be adapted to the needs of the operator and the particular end users involved. The MMC manages different sources to/from mobile terminals (e.g., such as the PDA 15 and the mobile communication device 35), supporting a wide range of standard interlaces.

In exemplary embodiments, the network 100 can be a managed IP network administered by a service provider, which can control bandwidth and quality of service for communications discussed herein. The network 1001 may be implemented in a wireless fashion, e.g., using wireless protocols and technologies, such as WiFi, WiMax, BLUETOOTH, etc. The network 100 can also be a packet-switched network, such as a local area network, a wide area network, a metropolitan area network, an internet network, or other similar types of networks. The network 100 may be a cellular communications network, a fixed wireless network, a wireless local area network (LAN), a wireless wide area network (WAN), a personal area network (PAN), a virtual private network (VPN), an intranet or any other suitable network, and the network 100 includes equipment for receiving and transmitting signals, such as a cell tower, a mobile switching center, a base station, and a wireless access point.

The system 100 can manage multiple accounts as established by particular users. These accounts correspond to a plurality of recipients who are registered to receive emergency notifications according to exemplary embodiments. These accounts may then be used to provide access to emergency notification services as described further herein.

As further shown in FIG. 1, the servers 110, 120, 130, 140 may be implemented using a high-speed processing device (e.g., a computer system) that is capable of handling high volume activities conducted with network entities via the network 100.

Furthermore, exemplary embodiments are not limited to but are capable of being implemented in the system 100 illustrated in FIG. 1. Additionally, the servers 110, 120, 130, 140 may be representative of numerous servers. Likewise, the network 100 may be representative of numerous networks. The plurality of communications devices discussed herein (such as the client devices 10, 20, 30, 40, personal digital assistant (PDA) 15, telephone 25, mobile communication device 35, facsimile machine 45, and computing devices 115, 125) may be representative of numerous communications devices. Therefore, the system 100 illustrated in FIG. 1 is neither limited numerically to the elements depicted therein nor limited to the exact configuration and operative connections of elements. Further, it is understood by those skilled in the art that elements may be added to, subtracted from, or substituted for the elements described in the system 100 of FIG. 1.

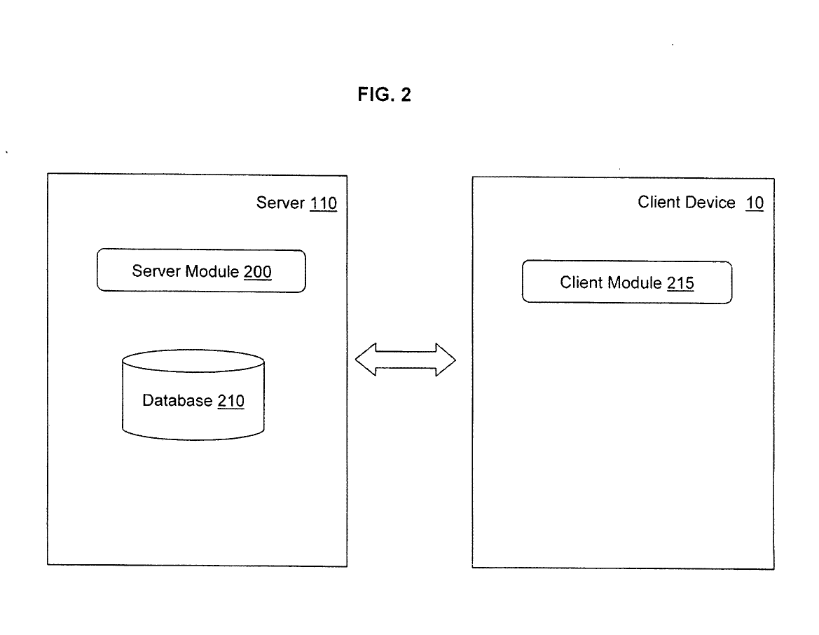

FIG. 2 illustrates an example of the server 110 interacting with the client device 10 in accordance with exemplary embodiments. The server 110 may host emergency notification services and may include a server module 200 and a database 210. The client device 10 may include a client module 215. The server 110 and the client device 10 may communicate over the network 100. Although non-limiting examples may illustrate the server 110 and the client device 10 in FIG. 2, it is understood that the functionality may be implemented on the client devices 20, 30, 40, the other servers 130, 140, and other communications devices.

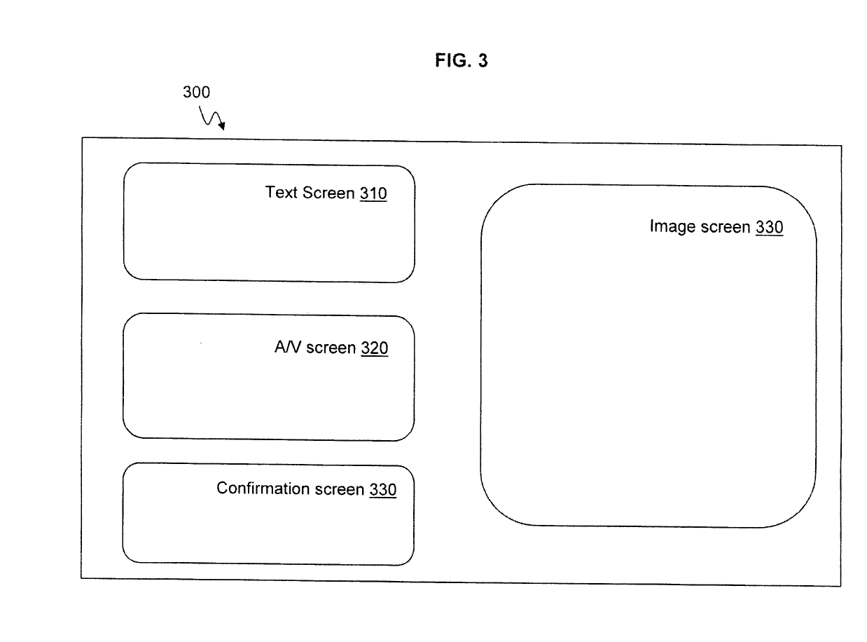

Referring to FIG. 1, using the computing device 115, a system administrator (such as an emergency management official) may log into an administration panel (e.g., illustrated in FIG. 3) of the server module 200 in accordance with exemplary embodiments. The administration panel may be a graphic user interface (GUI) for interacting with the server module 200. The administration panel allows the administrator to prepare and transmits various types of media in various formats for the client device 10 (and other communication devices such as the client devices 20, 30, 40, the PDA 15, telephone 25, mobile communications device 35, and the facsimile machine 45). The administration panel may be fully interactive and provide flexibility for the administrator to communicate his or her emergency notification to the respective recipients. The administration panel of the server module 200 can be activated from anywhere using a communications device, such as the computing device 115. During an emergency, the administrator may input/upload text, video, audio, images, etc. in the administration panel 200. As a non-limiting example, various types of media may be preloaded into the database 210. This media can be uploaded by the administrator and provided to the client device 10 (and others) in a push and/or pull method.

In an exemplary embodiment, the client module 215 may constantly poll a central database, such as the database 210 of the server 110. The client module 215 may check for flags on the database 110 via the server module 200. Newly set flags (which may be similar to emails) that have not been processed by the client device 10 can enter a queue on the client device 10, and the flags are presented to the client device 10. Each flag may carry or correspond to an emergency notification message title and description of the particular alert. In addition to the title and description of the alert, in another exemplary embodiment, the client module 215 can be configured to take over the viewable screen of the client device 10 and force the user to acknowledge the interruption as discussed further herein. In exemplary embodiments, a video from the broadcaster may immediately be streamed (live), or other pertinent instructions/information may be given.

A non-limiting example is provided below in accordance with exemplary embodiments. Referring to FIG. 3, an administrator may log into an administration panel 300. The administrator has the option of inputting text into a text screen 310) with a title and a message explaining the emergency. The administrator has the option of inputting an audio message, a video message, and/or and audio and video message in the A/V screen 320. Further, the administrator has the option of inputting images, such as maps, escape routes, GPS information, building schematics, etc. in an image screen 330. For example, the image screen 330 may be similar to an electronic whiteboard that can be in real-time or near real-time.

The recipients of the emergency notification can be unique to the particular organization employing the emergency notification system. The administrator has the option of choosing how many people or which groups of people should receive the emergency notification. For example, there can be an emergency that may affect people at a school, people at a mall, those in a building, coastal states of the United States, those on a highway about to cross a particular bridge, people in a certain country, etc. The groups of people who are clients are the server 110 can be segmented according any predefined standards or arbitrarily selected input. Each group may have a certain level of priority. There may be categories based on location of a group in a particular building, such as a school, so that teachers on one side of the building will receive one emergency notification and teachers on another side of the building will receive a different emergency notification. The instructions may be specific to the location of the teachers mid the particular details of the emergency.

In exemplary embodiments, the emergency notification may be retrieved by the client module 215 from the database of the server 110 after being properly authenticated by the server module 200. Also, the server module 200 may transmit the appropriate emergency notification to the recipients, such as the client module 215 of the client device 10. Each communication device may have a unique identification stored in the database 210 of the server 110, which may be an IP address, a telephone number, a URL, MAC address, etc. The unique identification may be used to transmit the appropriate emergency notification to the corresponding communication devices.

In accordance with exemplary embodiments, the emergency notification from the server module 200 triggers the client module 215 to cause an interruption of the client device 10. The interruption by the client module 215 causes an “overshadow” of the whole viewable desktop area of the client device 10. This overshadow forces the user of the client device 10 to interact with, respond to, and/or at least acknowledge the alert before moving on. The interruption is designed to affect the viewable screen of the desktop but not any active programs running on the client device 10. Once the emergency notification is complete and/or once the user of the client device 10 acknowledges the emergency notification alert, the viewable screen of the client device 10 can be released by the client module 215. Also, in exemplary embodiments, the administrator can release the viewable desktop of the client device 10. Further, the client module 215 may be configured to release control of the viewable desktop at the command of the recipient.

In FIG. 3, the administration panel 300 may also include a confirmation screen 330 that provides a confirmation for all recipients who have acknowledged and/or received the emergency notification at their respective communication devices. In the event of a large-scale disaster affecting a large group of recipients, the confirmations may not be displayed to the administrator and be stored in the database 210 for later analysis.

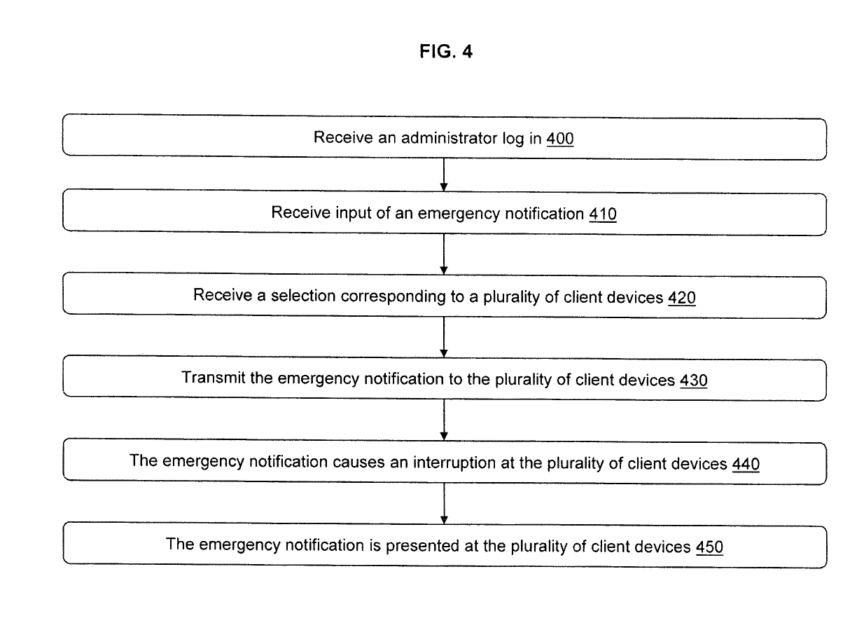

FIG. 4 illustrates a method of providing emergency notifications in accordance with exemplary embodiments.

An administrator login may be received at an administration panel 300 of the server module 200 at 400. The administrator may log into the server 110 from any computer, such as the computing devices 115, 125. The server module 200 receives input of an emergency notification at 410. As discussed herein, the emergency notification may be in various formats corresponding to the targeted communication device.

The server module 200 may receive input of a selection corresponding to a plurality of communication devices, such as the client devices 10, 20, 30, 40, the PDA 15, the telephone 25, the mobile communication device 35, the facsimile 45, etc at 420. For example, each communication device may correspond to particular users who are affected by the emergency. These users provide their desired means of contact in advance, and some users may provide multiple ways of being contacted. This information can be stored in the database 210.

The server module 200 may transmit the emergency notification to the plurality of communications devices (e.g., the client devices 10, 20, 30, 40) at 430. As a non-limiting example, in a push scenario, the server module 200 transmits the emergency notification to the selected people (or groups) over the network 100. As a non-limiting example, in a pull scenario, the client module 215 may poll the server 110 for updates, and when an update is discovered, the update is provided to the client module 215.

The emergency notification causes an interruption at the plurality of communications devices (or client devices) at 440. The interruption can be adjusted as desired to be less or more obtrusive on the communication device. As a non-limiting example, the interruption, e.g., at the client device 10, causes the viewable desktop of the client device 10 to be overshadowed. Other programs of the client device 10 continue to run unaffected in the background, and no unsaved data is lost.

The client module 215 presents the emergency notification on the plurality of communication devices (client devices) at 450.

In accordance with exemplary embodiments, as the viewable desktop of the plurality of communication devices (client devices) is being overshadowed, only the emergency notification is presented on the viewable desktop of the plurality of communication devices by the client module 215. The interruption at the plurality of communication devices causes programs running on the plurality of communication devices to be temporarily inoperable as the emergency notification is presented, and in response to completing presentation of the emergency notification, the programs operate as normal and no unsaved data is lost on the plurality of communication devices. Also, in response to presenting the emergency notification to the plurality of communication devices, the interruption is removed and the plurality of communication devices are released. Also, in exemplary embodiments, the emergency notification may appear briefly and can be removed by the recipient after being presented for that brief moment.

Further, in exemplary embodiments, an initial alert may be presented prior to the emergency notification. The initial alert may advise the recipients that the emergency notification will follow. The initial alert may include a title, a brief description of the emergency, and/or an audible sound. The initial alert allows the recipient to prepare for the ensuing news.

The interactions of the server module 200 and the client module 215 enable the emergency notification system to contact any number of people simultaneously with just a few commands. The server module 200 in conjunction with the client module 215 can interrupt (that is render inoperable) the desktop of the user's computer, such as the client device 10. The emergency notification system, however, does not corrupt ongoing programs or unsaved data running on the client device 10. The server 110 can ensure delivery and immediate confirmation of all urgent and emergency based desktop update messages on the client device 10.

The client module 215 may be implemented in a single executable program file. As a non-limiting example, the client module 215 can be implemented similar to any standard anti-virus protection program operating on various computer operating system platforms. The executable program file of the client module 215 may run as a system process that runs automatically at startup. The emergency notification system may check for updates based on a predetermined time interval. As a non-limiting example, the client module 215 may check for emergency notification updates on the server 110. This interval may be a variable unit and can be adjustable by the client module 215 or the server module 200. The emergency notification system may run a number of functions including authentication of specific users before dispensing urgent and emergency messages, instant text notification, streaming audio, streaming video, and the Department of Homeland Security alert flag. Exemplary embodiments are capable of implementing an unlimited number of easily programmable scenarios. These scenarios may include predefined groups respectively corresponding with the client devices 10, 20, 30, 40, where emergency notifications are transmitted to the targeted client devices 10, 20, 30, 40. In advance, data corresponding to the predefined groups (or individuals) are saved with a numeric identifier, a priority level, and a name, that may be triggered automatically by telephone, by a client, by external applications, or by external devices via a PLC interface, where some of these may sense alerting devices such as horns, sirens, lights, automatic door locks, etc.

In an exemplary embodiment, the client module 215 and the server module 200 may be be linked via a remote computer network to a third party communication service such as, RapidReach, to enable the emergency notification system to distribute messages to people via phone, two way pager, pager, fax, and e-mail, and registers all responses. The server module 200 may be predefined in the administration panel to register the recipients' responses to the emergency notification.

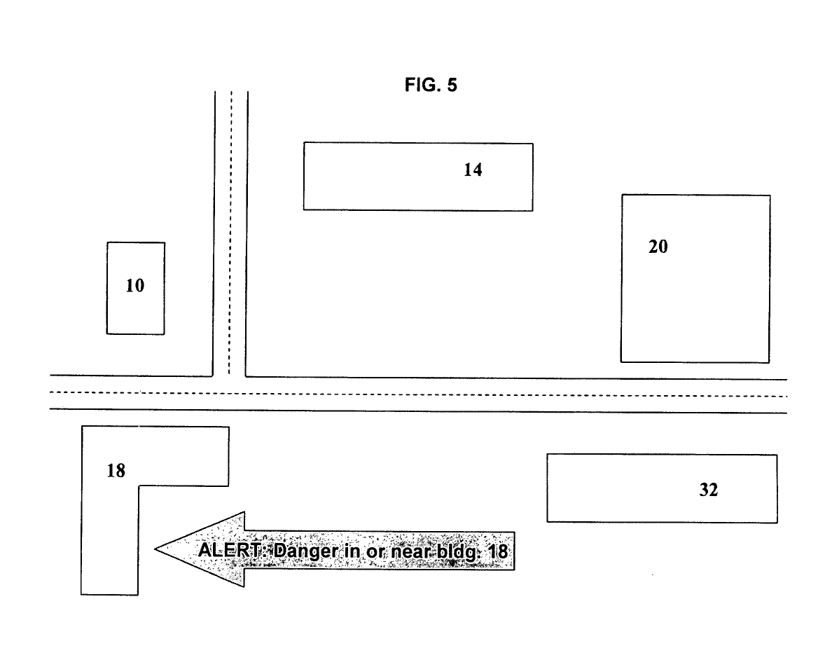

FIG. 5 illustrates a non-limiting example of implementing an emergency notification system on a college campus in accordance with exemplary embodiments. In this scenario, there may be an intruder on a college campus. The college may host the emergency notification system on the server 117. The emergency management official of the college may input a message (which may be text, video, and/or audio depending on the targeted communications device) and an image in the administration panel 300. The emergency notification message is transmitted to a plurality of communications devices in their respective formats, such as the client devices 10, 20, 30, 40, the PDA 15, the telephone 25, the mobile communications device 35, and the facsimile 45. If, e.g., the client module 215 is installed on the communication device, the client module 215 may be triggered to interrupt, e.g., the client device 10. The client module 215 may provide an initial alert to warn the recipient that an important message will follow. The initial alert may be provided in various forms with various amount of information about the emergency and is not meant to be limiting. Additionally, and/or alternatively, the emergency notification is presented on the communications device and the emergency notification overshadows the viewable desktop of the communication device. In addition to any text, audio, and/or video, the emergency notification may present the image 500 to the recipients. Image 500 of the emergency notification alerts the recipients that there is an intruder in building 18 and that building 18 should be avoided. Anyone in building 18 should leave immediately. This is just one non-limiting example, but it is understood that the features of the emergency notification system can apply and be adapted to an unlimited number of scenarios in accordance with exemplary embodiments.

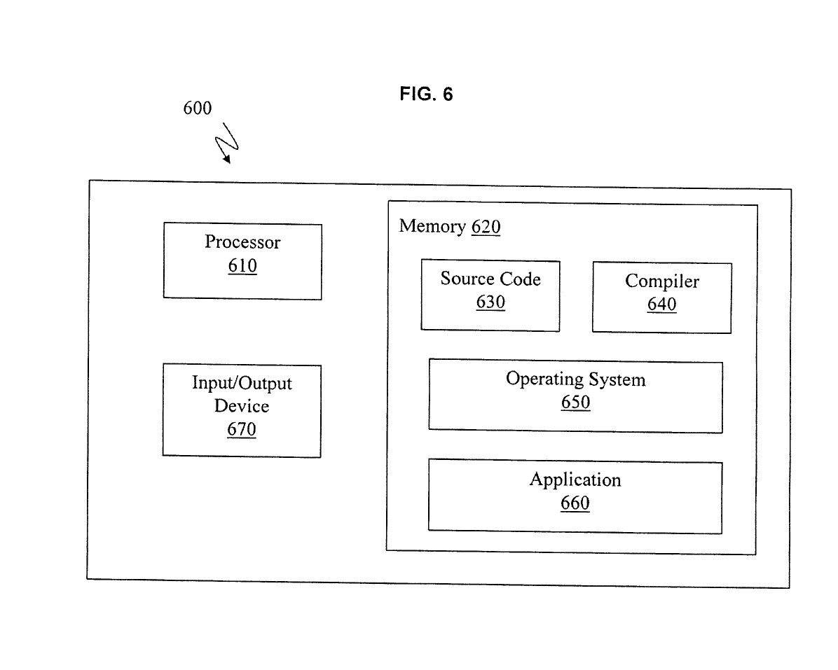

FIG. 6 illustrates an example of a computer 600 having capabilities, which may be included in exemplary embodiments. Various methods and systems discussed above may also utilize the capabilities of the computer 600. One or more of the capabilities of the computer 600 may be incorporated in any of the communications devices, such as the client devices 10, 20, 30, 40, the servers 110, 120, 130, 140, the computing devices 115, 125 and/or any element discussed herein.

The computer 600 includes, but is not limited to, PCs, workstations, laptops, PDAs, palm devices, Internet protocol enabled televisions, servers, and the like. Generally, in terms of hardware architecture, the computer 600 may include one or more processors 610, memory 620, and one or more input and/or output (I/O) devices 670 that are communicatively coupled via a local interface (not shown).

The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components. The processor 610 is a hardware device for executing software that can be stored in the memory 620. The processor 610 can be virtually any custom made or commercially available processor, a central processing unit (CPU), a data signal processor (DSP), or an auxiliary processor among several processors associated with the computer 600, and the processor 610 may be a semiconductor based microprocessor (in the form of a microchip) or a macroprocessor.

The memory 620 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the memory 620 may include one or more separate programs, each of which comprises an ordered listing of executable instructions for implementing logical functions. The software in the memory 620 includes a suitable operating system (O/S) 650, compiler 640, source code 630, and an application 660 (which may be one or more applications) of the exemplary embodiments. As illustrated, the application 660 comprises numerous functional components for implementing the features and operations of the exemplary embodiments. The application 660 of the computer 600 may represent the various applications and/or modules referred to herein, but the application 660 is not meant to be a limitation.

The operating system 650 controls the execution of other computer programs, and provides scheduling, input-output control, file and data management, memory management, and communication control and related services. It is contemplated by the inventors that the application 660 for implementing exemplary embodiments is applicable on all other commercially available operating systems.

The application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. Furthermore, the application 660 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 670 may include input devices such as, for example but not limited to a mouse, keyboard, scanner, microphone, camera, etc. Furthermore, the I/O devices 670 may also include output devices, for example but not limited to, a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such at the Internet.

If the computer 600 is a PC, workstation, intelligent device or the like, the software in the memory 620 may further include a basic input output system (BIOS) (omitted for simplicity). The BIOS is a set of essential software routines that initialize and test hardware at startup, start the O/S 650, and support the transfer of data among the hardware devices. The BIOS is stored in some type of read-only-memory, such as ROM, PROM, EPROM, EEPROM or the like, so that the BIOS can be executed when the computer 600 is activated.

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software it should be noted that the application 660 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 660 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 660 is implemented in hardware, the application 660 can be implemented with any one or a combination of the following technologies, which are each well known in the art: a discrete logic circuit(s) having logic gates for implementing logic functions upon data signals, an application specific integrated circuit (ASIC) having appropriate combinational logic gates a programmable gate array(s) (PGA), a field programmable gate array (FPGA), etc.

It is understood that the computer 600 includes non-limiting examples of software and hardware components that may be included in various devices and systems discussed herein, and it is understood that additional software and hardware components may be included in the various devices and systems discussed in exemplary embodiments.

Communication devices, networks, systems, Internet devices, PCs, PDAs, mobile devices, servers, client devices, etc., comprise all the hardware, software, modules, applications, and interfaces necessary to operate and function as described herein.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part off a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments have been described, it will be understood that those skilled in the art, both now and in the future, may make various improvements and enhancements which fall within the scope of the claims which follow. These claims should be construed to maintain the proper protection for the invention first described.

1. A method for emergency notification, comprising:
receiving an administrator login;
receiving input of an emergency notification;
receiving a selection corresponding to a plurality of client devices;
transmitting the emergency notification to the plurality of client devices;
wherein the emergency notification causes an interruption at the plurality of client devices; and
wherein the emergency notification is presented at the plurality of client devices.

2. The method of claim 1, wherein the interruption at the plurality of client devices causes a viewable desktop of the plurality of client devices to be overshadowed.

3. The method of claim 2, wherein as the viewable desktop of the plurality of client devices is being overshadowed, respective programs of the plurality of client devices run in a background.

4. The method of claim 2, wherein as the viewable desktop of the plurality of client devices is being overshadowed, only the emergency notification is presented on the viewable desktop of the plurality of client devices.

5. The method of claim 1, wherein the interruption at the plurality of client devices causes programs running on the plurality of client devices to be temporarily inoperable as the emergency notification is presented; and
wherein in response to completing presentation of the emergency notification, the programs operate as normal and no unsaved data is lost on the plurality of client devices.

6. The method of claim 1, wherein in response to presenting the emergency notification to the plurality of client devices, the interruption is removed and the plurality of client devices are released.

7. The method of claim 1, wherein an initial alert is presented prior to the emergency notification; and
wherein the initial alert advises that the emergency notification will follow.

8. The method of claim 7, wherein the initial alert comprises at least one of:
a title;
a brief description an emergency; and
an audible sound.

9. A communications device configured to receive emergency notifications, comprising:
memory for storing a client module for providing emergency notification; and
a processor, functionally coupled to the memory, the processor being responsive to computer-executable instructions contained in the client module and operative to:
receive an emergency notification at the communications device;
cause an interruption at the communications device, in response to receiving the emergency notification;
wherein the interruption renders programs running on the communications device to be inoperable during the interruption; and
present the emergency notification at the communication device.

10. The communications device of claim 9, wherein the interruption causes a viewable desktop of the communication device to be overshadowed.

11. The communications device of claim 10 wherein as the viewable desktop of the communications device is being overshadowed respective programs of the communications device run in a background.

12. The communications device of claim 10 wherein as the viewable desktop of the communications device is being overshadowed, only the emergency notification is presented on the viewable desktop of the communications device.

13. The communications device of claim 9, wherein after the emergency notification is complete the programs continue running as normal and no unsaved data is lost.

14. The communications device of claim 9, wherein an initial alert is presented prior to the emergency notification; and
wherein the initial alert advises that the emergency notification will follow.

15. The method of claim 14, wherein the initial alert comprises at least one of:
a title;
a brief description an emergency; and
an audible sound.

16. A computer program product, tangibly embodied on a computer readable medium, for providing emergency notification, the computer program product including instructions for causing a computer to execute a method, comprising:
receiving an administrator login;
receiving input of an emergency notification;
receiving a selection corresponding to a plurality of client devices;
transmitting the emergency notification to the plurality of client devices;
wherein the emergency notification causes an interruption at the plurality of client devices; and
wherein the emergency notification is presented at the plurality of client devices.

17. The computer program product of claim 16, wherein the interruption at the plurality of client devices causes a viewable desktop of the plurality of client devices to be overshadowed.

18. The computer program product of claim 17, wherein as the viewable desktop of the plurality of client devices is being overshadowed, respective programs of the plurality of client devices run in a background.

19. The computer program product of claim 17, wherein as the viewable desktop of the plurality of client devices is being overshadowed, only the emergency notification is presented on the viewable desktop of the plurality of client devices.

20. The computer program product of claim 16, wherein the interruption at the plurality of client devices causes programs running on the plurality of client devices to be temporarily inoperable as the emergency notification is presented; and
wherein in response to completing presentation of the emergency notification, the programs operate as normal and no unsaved data is lost on the plurality of client devices.
